(19) United States
(12) Patent Application Publication
(10) Pub. No.: US 2009/0202068 A1
(43) Pub. Date: Aug. 13, 2009

(54) MEDIA SECURITY THROUGH HARDWARE-RESIDENT PROPRIETARY KEY GENERATION

(76) Inventors: AMJAD QURESHI, San Jose, CA (US); Babu Chilukuri, Cupertino, CA (US)

Correspondence Address: Raj Abhyanker LLP;c/o Intellevate, P.O. Box 52050, Minneapolis, MN, 55402, US

(21) Appl. No.: 12/027,279

(22) Filed: Feb. 7, 2008

(51) Int. Cl. H04L 9/00

(52) U.S. Cl. 380/44

(57) ABSTRACT

A method, system and apparatus of an author website in a commerce environment are disclosed. In one embodiment, a system includes a host processor; a first security circuit to re-encrypt a work of authorship protected by an encryption standard using a proprietary key after an authorization module uses an algorithm of the encryption standard to verify that the system has permission to playback the work of authorship; a system memory to store a proprietary encrypted content generated through the re-encryption process of the first security circuit; and a second security circuit of a display module to independently generate the proprietary key using an index pointer provided from the first security circuit to the second security circuit through the host processor and to decrypt the proprietary encrypted content of the system memory using the independently generated proprietary key.

### FIELD OF TECHNOLOGY

This disclosure relates generally to the technical field of communications and, in one example embodiment, to a method, apparatus, and system of media security through hardware-resident proprietary key generation.

### BACKGROUND

A content provider (e.g., a studio, a record label, a publisher, a developer etc.) may own a copyright interest in a work of authorship (e.g., a movie, a record, a book, a software application, etc.). The content provider may wish to protect the work of authorship from unauthorized broadcast, duplication, and/or dissemination. To protect the work of authorship, the content provider may create an encrypted content by employing an encryption standard (e.g., AACS, BD+, HDCP, DTCP-IP, a proprietary standard, etc.) to a media (e.g., a HD DVD, a BlueRay disk, etc.) having the work of authorship.

A device (e.g., a computer, a standalone player, etc.) may use a software application (e.g., media player application) to decode the encrypted content using a technique authorized by a governing body (e.g., AACS Licensing Administrator LLC, etc.) of the encryption standard. The software application may temporarily store the encrypted content and a key to decrypt the encrypted content on a system memory. In addition, because the software application may not be able to decode the encrypted content as fast as it may be able to play back the work of authorship, the software application may utilize a video buffer (e.g., may be stored in a cache memory, the system memory, etc.) to temporarily store the work of authorship prior to playback on a display (e.g., a monitor, a LCD screen, a television, etc.).

A hacker (e.g., one who uses programming skills to gain illegal access to a computer network or file) may surreptitiously access the encrypted content and the key to decrypt the encrypted content in the system memory. The hacker may then use the key to decrypt the encrypted content to gain access to the work of authorship. Alternatively, the hacker may gain access to the video buffer and copy the work of authorship to an unsecure location. In such scenarios, the hacker may then broadcast, duplicate and/or disseminate the work of authorship without permission of the content provider. As a result, the content provider may lose the protection of the work of authorship they desired when employing the encryption standard.

### SUMMARY

A method, system and apparatus of media security through hardware-resident proprietary key generation are disclosed. In one aspect, a system includes a host processor; a first security circuit to re-encrypt a work of authorship (e.g., a video content, a motion-picture content, an audio content, a music content, a lyrical content, a graphical and/or a textual content) protected by an encryption standard (e.g., Advanced Access Content System (AACS) standard, a BD+ (Blu-ray Disc) standard, a High-bandwidth Digital Content Protection (HDCP) standard, a Digital Transmission Content Protection over Internet Protocol (DTCP-IP) standard, and a proprietary standard) using a proprietary key (e.g., at least a 128 bit key) after an authorization module uses an algorithm of the encryption standard to verify that the system has permission to playback the work of authorship.

In this aspect, a system memory stores a proprietary encrypted content generated through the re-encryption process of the first security circuit. A second security circuit of a display module may independently generate the proprietary key using an index pointer provided from the first security circuit to the second security circuit through the host processor. The second security circuit may decrypt the proprietary encrypted content of the system memory using the independently generated proprietary key. A key generator circuit of the first security circuit and the second security circuit may generate the proprietary key using a key generator circuit of the first security circuit and the second security circuit to generate the proprietary key using a hash table, a number generator, a unique work of authorship identifier, and optionally a unique system identifier (e.g., the number generator and the hash table of the first security circuit and the second security circuit may be exactly the same).

The index pointer may point to a location in embedded memory of the first security circuit and the second security circuit having identical data to enable the key generator circuit of the second circuit to independently generate the proprietary key matching that of the first circuit. A power saving circuit of the first security circuit and/or the second circuit may adjust a voltage and frequency of at least one clock, memory, gate, and sub-circuit when not in operation to reduce power consumption of the system. The display module may decompress the work of authorship after the decryption of the proprietary encrypted content. The display may also encrypt the decompressed content with a system master key provided from the display module and/or the host processor prior to sending the content to at least one of a video buffer and a display.

In another aspect, a method of an authorization module includes applying an algorithm of a encryption standard to verify that a playback device has permission to playback the work of authorship, re-encrypting the work of authorship protected by the encryption standard using a first hardware circuit that generates a proprietary key stored only in embedded hardware memory of the hardware circuit to re-encrypt the work of authorship, and storing a proprietary encrypted content generated through the re-encryption process in a system memory without storing any key information to decrypt the proprietary encrypted content in the system memory.

The method may communicate an index pointer to a hash table and/or a number generator to a display module through a host processor. The method may independently generate the proprietary key using an index pointer provided from the first hardware circuit associated with the authorization module to a second hardware circuit associated with the display module. The second hardware circuit may be used to decrypt the proprietary encrypted content of the system memory using the independently generated proprietary key. The proprietary key may be generated using a hash table, a number generator and/or a unique identifier of a playback device. The number generator and the hash table of the first security circuit and the second security circuit may be exactly the same. The index pointer may reference a location in embedded memory of the first security circuit and the second security circuit having identical data to enable the key generator circuit of the second circuit to independently generate the proprietary key matching that of the first security circuit. The index handshaking may require identical circuitry in both the first security circuit and the second security circuit (e.g., in both SoCs or System-on-Chips). The index handshaking may be user dependent and/or configurable (e.g., each customer may have different key/seed generators).

A voltage and frequency of at least one clock, memory, gate, and sub-circuit may be adjusted when not in operation to reduce power consumption. The proprietary key may be at least a 128 bit key. The work of authorship may include a video content, a motion-picture content, an audio content, a music content, a lyrical content, a graphical content, and/or a textual content. The display module may decompress the work of authorship after the decryption of the proprietary encrypted content.

In yet another aspect a playback device includes an authentication component to verify that a protected content is authorized to be viewed on the playback device; a media security circuitry to re-encrypt the protected content using a proprietary key after it is authorized to be viewed on the playback device using a secure embedded memory of the media security circuitry; and a display component to receive the re-encrypted content from a system memory and to reference the media security circuitry to provide the proprietary key to decrypt the re-encrypted content.

A memory map of the secure embedded memory and all hardware registers may never visible to software. The playback device may be individually permitted to access the protected content through a broadcast encryption scheme such that only qualified subscribers of an encryption standard are permitted to access the protected content.

The methods, system, and apparatuses disclosed herein may be implemented in any means for achieving various aspects, and may be executed in a form of machine-readable medium embodying a set of instruction that, when executed by a machine, causes the machine to perform any of the operation disclosed herein. Other features will be apparent from the accompanying drawing and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a block diagram of a playback device communicating with a media, according to one embodiment.

FIG. 2 is an exploded view of the playback device of FIG. 1 having an authorization module and a display module, according to one embodiment.

FIG. 3 is a network view of a content provider and a content library associated with the playback device of FIG. 1 through a network, according to one embodiment.

FIG. 4 is an exploded view of the authorization module of FIG. 2, according to one embodiment.

FIG. 5 is a process flow of refreshing a set of base keys according to one embodiment.

FIG. 6 is a process flow of a method of the authorization module of FIG. 2, according to one embodiment.

Other features of the present embodiments will be apparent from the accompanying drawings and from the detailed description that follows.

### DETAILED DESCRIPTION

A method apparatus and system of an author website in a commerce environment are disclosed. In the following description, for the purposes of explanation, numerous specific details are set forth in order to provide a thorough understanding of the various embodiments. It will be evident, however to one skilled in the art that the various embodiments may be practiced without these specific details.

In one embodiment, a system (e.g., a playback device 102) includes a host processor (e.g., a host processor 204); a first security circuit (e.g., a first security circuit 208) to re-encrypt a work of authorship protected by an encryption standard using a proprietary key (e.g., a proprietary key 214A) after an authorization module uses an algorithm of the encryption standard to verify that the system has permission to playback the work of authorship; a system memory (e.g., a system memory 206) to store a proprietary encrypted content generated through the re-encryption process of the first security circuit; and a second security circuit (e.g., a second security circuit 210) of a display module (a display module 202) to independently generate the proprietary key (e.g., a proprietary key 214B) using an index pointer (e.g., an index pointer 224) provided from the first security circuit to the second security circuit through the host processor and to decrypt the proprietary encrypted content of the system memory using the independently generated proprietary key.

In another embodiment, a method of an authorization module (e.g., the authorization module 200) includes applying an algorithm of an encryption standard to verify that a playback device (e.g., the playback device 102) has permission to playback the work of authorship; re-encrypting the work of authorship protected by the encryption standard using a first hardware circuit that generates a proprietary key stored only in embedded hardware memory (e.g., the embedded memory 222A) of the first hardware circuit to re-encrypt the work of authorship; and storing a proprietary encrypted content (e.g., a proprietary encrypted content 226) generated through the re-encryption process in a system memory (e.g., a system memory 206) without storing any key information to decrypt the proprietary encrypted content in the system memory.

In yet another embodiment, a playback device (e.g., a playback device 102) includes an authentication component (e.g., the authorization module 200) to verify that a protected content is authorized to be viewed on the playback device; a media security circuitry (e.g., the first security circuit 208 and/or the second security circuit 210) to re-encrypt the protected content using a proprietary key (e.g. the proprietary keys 214) after it is authorized to be viewed on the playback device using a secure embedded memory of the media security circuitry; and a display component (e.g., the display module 202 and the display 228) to receive the re-encrypted content from a system memory and to reference the media security circuitry to provide the proprietary key to decrypt the re-encrypted content.

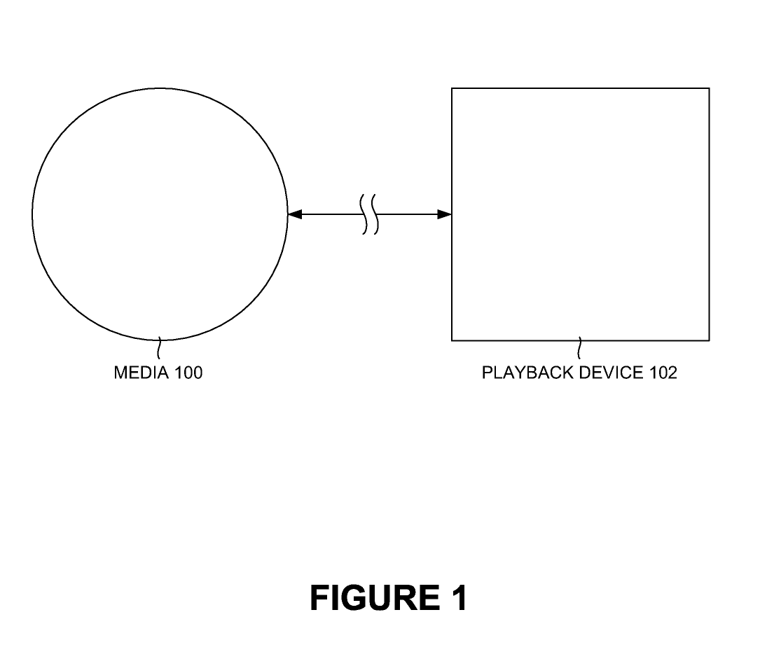

FIG. 1 is a block diagram of a playback device 102 communicating with a media 100, according to one embodiment. The media 100 may be a HD-DVD disk and/or a Blue-Ray disc having a work of authorship (e.g., a movie, a television show, a play, a music data, etc.). In an alternate embodiment, the media may be received via any networking protocol (e.g., wireless or wired protocol). The playback device 102 may be a personal computer, a standalone media player, a mobile audio/video player, a mobile phone, and/or a kiosk. The system (e.g., the playback device 102 of FIG. 1) may utilize an encryption standard such as an Advanced Access Content System (AACS) standard, a BD+ (Blu-ray Disc) standard, a High-bandwidth Digital Content Protection (HDCP) standard, a Digital Transmission Content Protection over Internet Protocol (DTCP-IP) standard, and/or a proprietary standard. The work of authorship (e.g., stored on the media 100 of FIG. 1) may include a video content, a motion-picture content, an audio content, a music content, a lyrical content, a graphical content, and/or a textual content.

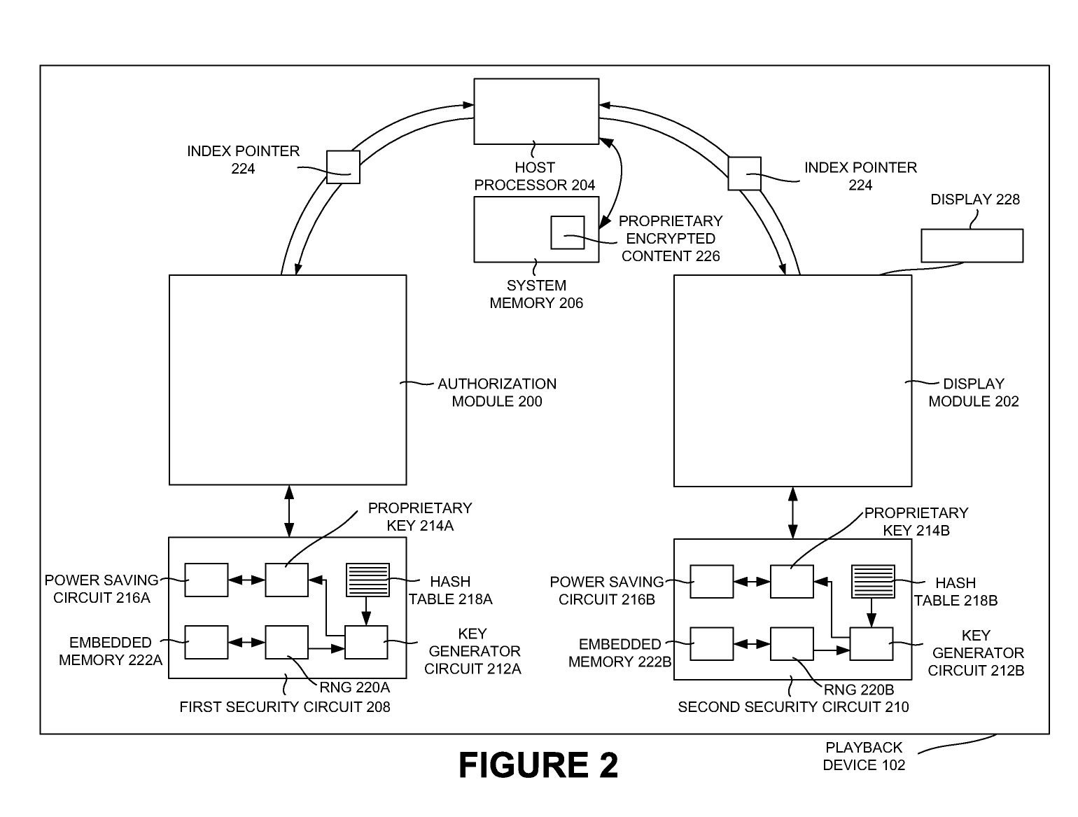

The playback device 102 of FIG. 1 includes an authentication component (e.g., an authorization module 200 of FIG. 2) to verify that a protected content (e.g., on the media 100) is authorized to be viewed on the playback device 102. The playback device 102 also includes a media security circuitry (e.g., a first security circuit 208 and/or a second security circuit 210 of FIG. 2) to re-encrypt the protected content using a proprietary key 214A after it is authorized to be viewed on the playback device 102 using a secure embedded memory (e.g., the embedded memory 222A and/or the embedded memory 222B) of the media security circuitry.

The playback device 102 also includes a display component (e.g., the display module 202 and/or the display 228) to receive the re-encrypted content from a system memory 206 and to reference the media security circuitry (e.g., a first security circuit 208 and/or a second security circuit 210 of FIG. 2) to provide the proprietary key (e.g., the proprietary key 214 of FIG. 2) to decrypt the re-encrypted content (e.g., the proprietary encrypted content 226 of FIG. 2). The playback device 102 may have a memory map (e.g., of the secure embedded memory and all hardware registers) which is never visible to software (e.g., the memory map may be entirely in hardware).

FIG. 2 is an exploded view of the playback device 102 of FIG. 1 having an authorization module 200 and a display module 202, according to one embodiment. The playback device 102 as shown in FIG. 2 includes a first security circuit 208 communicating with the authorization module 200 and a second security circuit 210 communicating with a display module 202. The first security circuit 208 includes a key generator circuit 212A, a proprietary key 214A, a power saving circuit circuitry 216A, a hash table 218A, a random number generator (RNG) 220A, and an embedded memory 222A. Similarly, the second security circuit 210 includes a key generator circuit 212B, a proprietary key 214B, a power saving circuit circuitry 216B, a hash table 218B, a random number generator (RNG) 220B, and an embedded memory 222B.

The authorization module 200 of FIG. 2 is illustrated as communicating with the display module 202 through the host processor 204. The host processor 204 may be coupled to a system memory 206 having a proprietary encrypted content 226. The display module 202 is illustrated as being coupled to a display 228 in the embodiment illustrated in FIG. 2. The authorization module 200 and the display module 202 may be created in software and/or in hardware. In one embodiment, the authorization module and the display module 202 is created entirely in hardware. The authorization module may verify that the playback device 102 is authorized to play a particular type of media and/or work of authorship. The display module 202 may decompress the media and/or the work of authorship.

The first security circuit 208 may re-encrypt a work of authorship (e.g., stored on the media 100 of FIG. 1) protected by an encryption standard using a proprietary key 214A after an authorization module 200 uses an algorithm of the encryption standard to verify that the system (e.g., the playback device 102 of FIG. 1) has permission to playback the work of authorship (e.g., stored on the media 100 of FIG. 1). The system memory 206 may store a proprietary encrypted content 226 generated through the re-encryption process of the first security circuit 208.

The second security circuit 210 may independently generate the proprietary key 214B using an index pointer 224 provided from the first security circuit 208 to the second security circuit 210 through the host processor 204. The index handshaking may require identical circuitry in both the first security circuit and the second security circuit (e.g., in both SoCs or System-on-Chips). The index handshaking may be user dependent and/or configurable (e.g., each customer may have different key/seed generators). Alternatively, in an embodiment in which the first security circuit and the second security circuit are combined into a single SoC (e.g., System on Chip), the index handshaking mechanism may be completely eliminated (e.g., when the single SoC is integrated with Codecs and/or when Codec logic is added to the media security circuitry described here).

The second security circuit 210 may decrypt the proprietary encrypted content 226 of the system memory 206 using the independently generated proprietary key 214B. The key generator circuit 212 (e.g., of the first security circuit 208 and/or the second security circuit 210) may generate the proprietary key 214A using a hash table 218A, a number generator (e.g., Random Number Generator RNG 220A), a unique work of authorship identifier (e.g., a title key), and optionally a unique system identifier. In one embodiment, it is important that the number generator (e.g., Random Number Generator RNG 220) and the hash table 218 of the first security circuit 208 and the second security circuit 210 are exactly the same.

The index pointer 224 may point to a location in embedded memory (e.g., the embedded memory 222A and/or the embedded memory 222B) of the first security circuit 208 and/or the second security circuit 210. The embedded memory location may have identical data to enable the key generator circuit 212B of the second security circuit 210 to independently generate the proprietary key 214B matching that of the first security circuit 208. A power saving circuit (e.g., the power saving circuit 216A and/or the power saving circuit 216B) of the first security circuit 208 and/or the second security circuit 210 may adjust voltage and frequency of at least one clock, memory, gate, and/or sub-circuit when not in operation to reduce power consumption of the system (e.g., the playback device 102 of FIG. 1). The proprietary key 214 may be at least a 128 bit key. The display module 202 may decompress the work of authorship (e.g., stored on the media 100 of FIG. 1) after the decryption of the proprietary encrypted content 226.

The display module 202 may encrypt the decompressed content with a system master key provided from at least one of the display module 202 and the host processor 204 prior to sending the content to at least one of a video buffer (e.g., of the system memory 206) and a display 228. The authorization module 200 may apply an algorithm of an encryption standard (e.g., AACS) to verify that a playback device 102 has permission to playback the work of authorship (e.g., stored on the media 100 of FIG. 1).

The authorization module 200 may re-encrypt the work of authorship (e.g., stored on the media 100 of FIG. 1) protected by the encryption standard using a first hardware circuit (e.g., the first security circuit 208) that generates a proprietary key 214A stored only in embedded hardware memory (e.g., the embedded memory 222 of FIG. 2) of the hardware first circuit. The authorization module 200 may store a proprietary encrypted content 226 generated through the re-encryption process in a system memory 206 without storing any key information to decrypt the proprietary encrypted content 226 in the system memory 206 (e.g., such that the second security circuit has to independently recreate the key before decrypting).

The index pointer 224 may be communicated to a to a display module 202 through a host processor 204. The second hardware circuit (e.g., the second security circuit 210) may independently generate the proprietary key using the index pointer 224 provided from the first hardware circuit (e.g., the first security circuit 208) associated with the authorization module 200 to a second hardware circuit (e.g., the second security circuit 210) associated with the display module 202. The second hardware circuit (e.g., the second security circuit 210) may be used to decrypt the proprietary encrypted content 226 of the system memory 206 using the independently generated proprietary key 214B.

The proprietary key may be generated using the hash table 218A, the number generator (e.g., Random Number Generator RNG 220A), a unique work of authorship identifier (e.g., a title key), and optionally a unique system identifier (e.g., a MAC address or unique processor serial number).

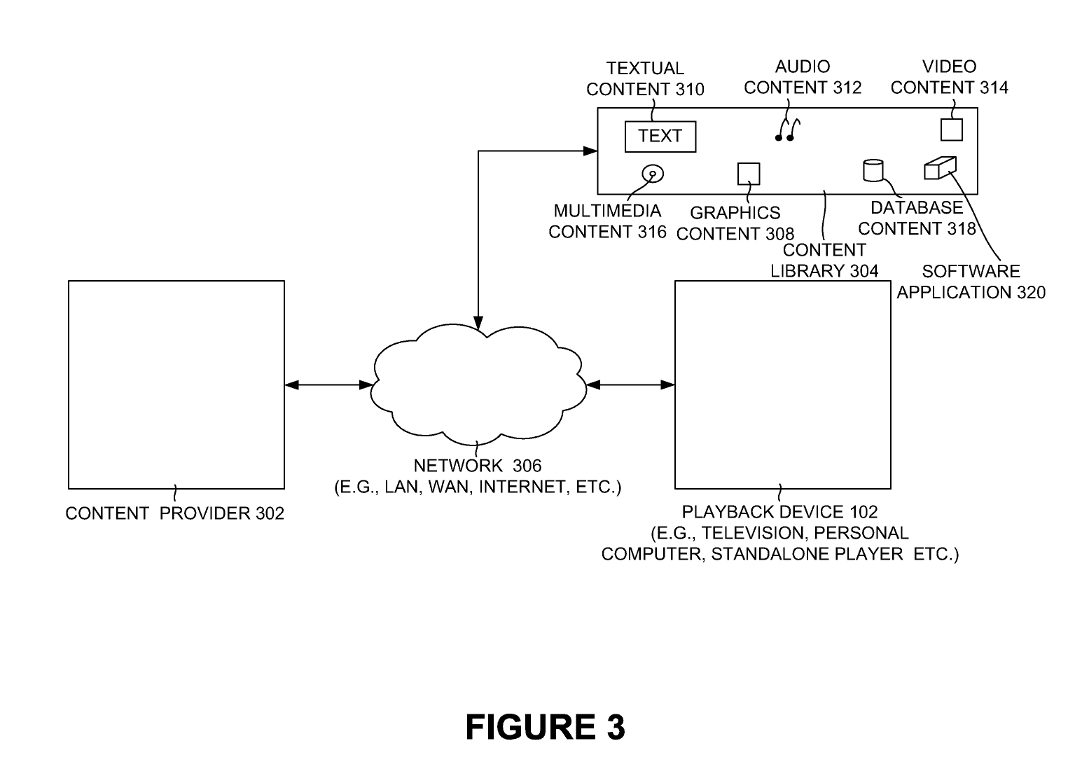

FIG. 3 is a network view of a content provider 302 and a content library 304 associated with the playback device 102 of FIG. 1 through a network 306, according to one embodiment. The content provider 302 may be an owner of a copyright interest of a work of authorship embodied on the media 100 of FIG. 1 (e.g., a record label, a publisher, a studio, etc.). The network 306 may be a local area network, a wide area network, the Internet, etc. The playback device may communicate with the content provider 302 to request and receive authentication keys (e.g., title keys) so that it may play back one or more works of authorship in the content library 304.

The content library 304 is illustrated as including a graphics content 308, a textual content 310, an audio content 312, a video content 314, a multimedia content 316, a database content 318, and a software application 320. The various types of content of the content library 304 may be works of authorship that are played back by the playback device 102 after receiving authorization from the content provider 302.

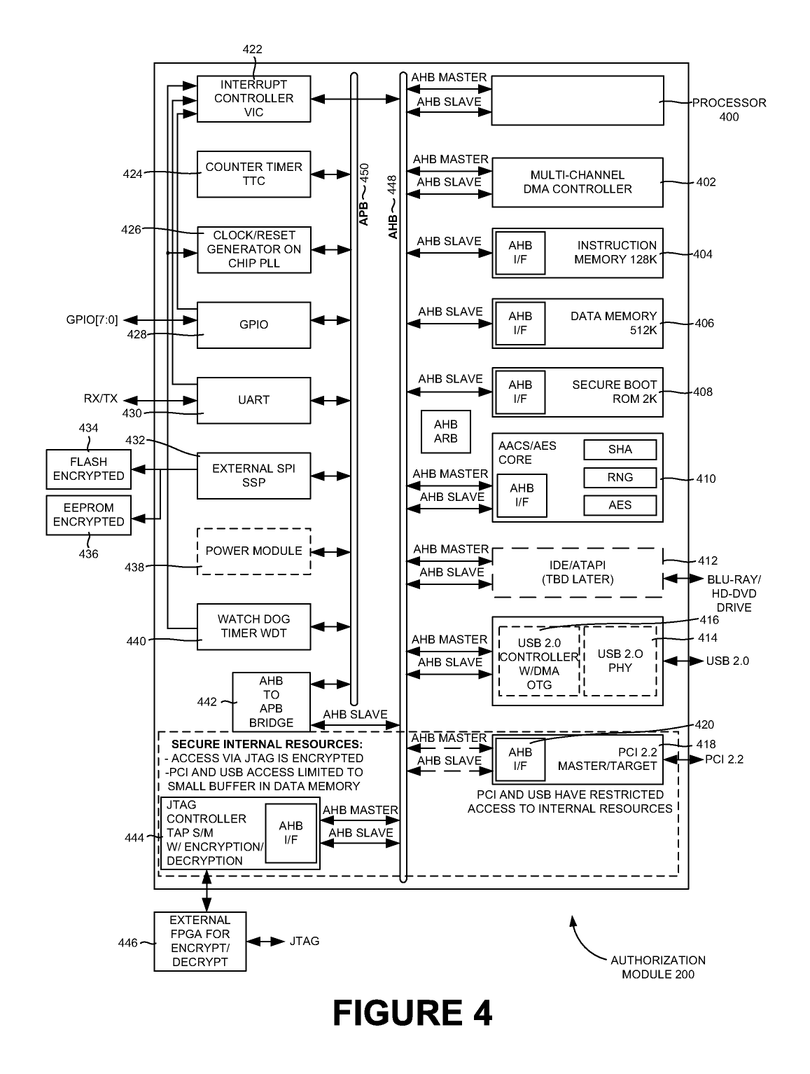

FIG. 4 is an exploded view of the authorization module 200 of FIG. 2, according to one embodiment. The authorization module 200 as illustrated in FIG. 4 includes a processor 400, a multi-channel DMA controller 402, an instruction memory 404, a data memory 406, a 2 KB secure boot ROM 408, an encryption block 410, a standard controller block 412, a set of USB controller circuitry (e.g., 414 and 416), and a set of secure internal resources (e.g., including a JTAG controller 444, A PCI 2.2 master/target block 418, and a AHB I/F block 420).

The authorization module 200 is also illustrated as including an interrupt controller 422, a counter timer 424, a clock reset generator 426, a GPIO 428, a UART 430, an external SPI SSP coupled to an encrypted Flash 434 and an encrypted EEPROM 436, a power module 438, a watch dog timer 440, and an AHB to APB bus bridge 442. Also illustrated in FIG. 4 is an external FPGA 446 for encryption/decryption of the secure JTAG controller.

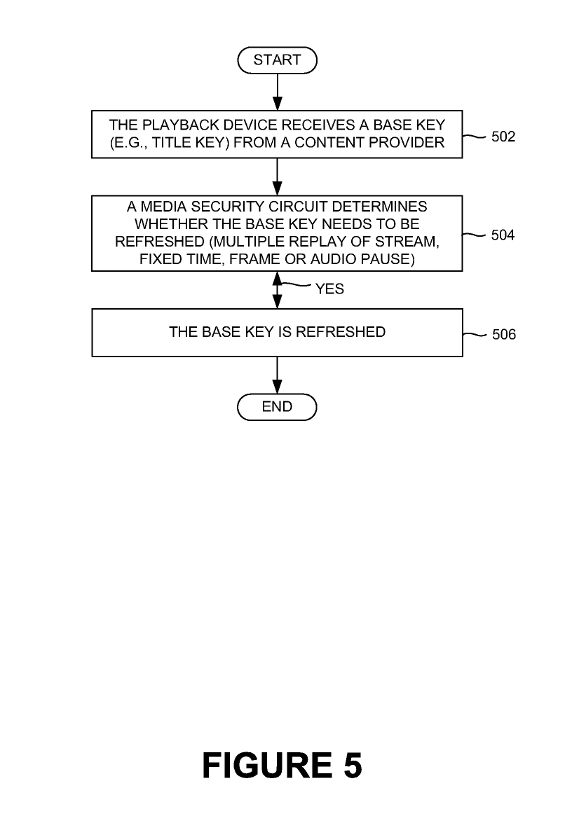

FIG. 5 is a process flow of refreshing a set of base keys according to one embodiment. In operation 502, the playback device 102 receives a base key (e.g., at title key) from a content provider (e.g., the content provider 302). In operation 504, a media security circuit (e.g., the first security circuit 208 and/or the second security circuit 210) determines whether the base key needs to be refreshed (e.g., because of things such as multiple replay of a stream of video, after a fixed amount of time, after a frame or audio pause, etc.). If it is determined that the base key needs to be refreshed, in operation 506, the base key is refreshed. The base key refreshing process of FIG. 5 may provide additional security to the playback device 102 of FIG. 1 and FIG. 2 when certain types of the encryption standard are used (e.g., AACS). The base key refreshing technique may be used by the key generator circuits 212 in creating the proprietary key 214.

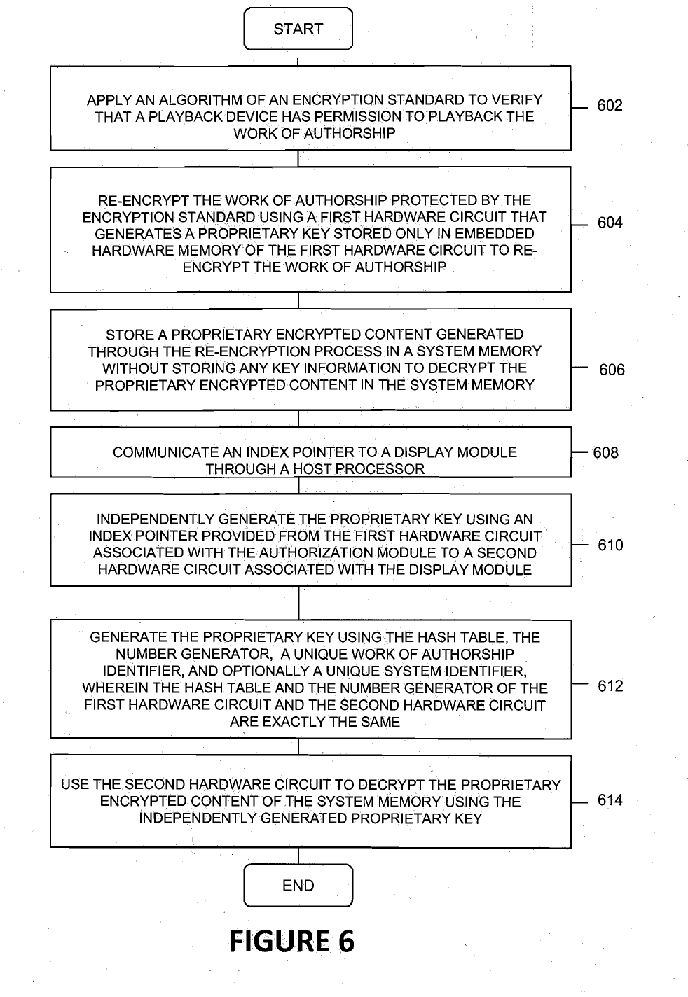

FIG. 6 is a process flow of a method of the authorization module of FIG. 2, according to one embodiment. In operation 602, an algorithm of an encryption standard (e.g., AACS, BD+, HDCP, DTCP-IP, a proprietary standard, etc.) to a media (e.g., a HD DVD, a BlueRay disk, etc.) may be applied to verify that a playback device (e.g., the playback device 102) has permission to playback the work of authorship (e.g., on the media 100 of FIG. 1). In operation 604, the work of authorship protected by the encryption standard may be re-encrypted using a first hardware circuit (e.g., the first security circuit 208 of FIG. 2) that generates a proprietary key (e.g., the proprietary key 214A) stored only in embedded hardware memory (e.g., the embedded hardware memory 222A) of the first hardware circuit to re-encrypt the work of authorship. Then, in operation 606, a proprietary encrypted content (e.g., the proprietary encrypted content 226 of FIG. 2) generated through the re-encryption process may be stored in a system memory (e.g., the system memory 206 of FIG. 2) without storing any key information to decrypt the proprietary encrypted content in the system memory.

Next, in operation 608, an index pointer (e.g., the index pointer 224 of FIG. 2) may be communicated to a display module (e.g., the display module 202 of FIG. 2) through a host processor (e.g., the host processor 204 of FIG. 2). Then in operation 610, the proprietary key (e.g., the proprietary key 214B of FIG. 2) may be independently generated using an index pointer (e.g., the index pointer 224 of FIG. 2) provided from the first hardware circuit (e.g., the first security circuit 208 of FIG. 2) associated with the authorization module (e.g., the authorization module 200 of FIG. 2) to a second hardware circuit (e.g., the second security circuit 210 of FIG. 2) associated with the display module (e.g., the display module 202 of FIG. 2). In operation 612, the proprietary key (e.g., the proprietary key 214B of FIG. 2) may be generated using the hash table (e.g., the hash table 218B), the number generator (e.g., the random number generator 220B), a unique work of authorship identifier (e.g., a title key), and optionally a unique system identifier (e.g., the hash table and the number generator of the first hardware circuit and the second hardware circuit are exactly the same). In operation 614, the second hardware circuit (e.g., the second security circuit 210 of FIG. 2) may be used to decrypt the proprietary encrypted content of the system memory (e.g., the system memory 206 of FIG. 2) using the independently generated proprietary key (e.g., the proprietary key 214B of FIG. 2).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated Circuitry (ASIC) and/or in Digital Signal Processor (DSP) circuitry). For example, the authorization module 200 and the display module 202 of FIG. 2 may be enabled using an authorization circuit, a display circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A system comprising:
a host processor;
a first security circuit to re-encrypt a work of authorship protected by an encryption standard using a proprietary key after an authorization module uses an algorithm of the encryption standard to verify that the system has permission to playback the work of authorship;
a system memory to store a proprietary encrypted content generated through the re-encryption process of the first security circuit; and
a second security circuit of a display module to independently generate the proprietary key using an index pointer provided from the first security circuit to the second security circuit through the host processor and to decrypt the proprietary encrypted content of the system memory using the independently generated proprietary key.

2. The system of claim 1 further comprising a key generator circuit of the first security circuit and the second security circuit to generate the proprietary key using a hash table, a number generator, a unique work of authorship identifier, and optionally a unique system identifier wherein the number generator and the hash table of the first security circuit and the second security circuit is exactly the same.

3. The system of claim 2 wherein the index pointer points to a location in embedded memory of the first security circuit and the second security circuit having identical data to enable the key generator circuit of the second circuit to independently generate the proprietary key matching that of the first circuit.

4. The system of claim 3 wherein the encryption standard is at least one of an Advanced Access Content System (AACS) standard, a BD+ (Blu-ray Disc) standard, a High-bandwidth Digital Content Protection (HDCP) standard, a Digital Transmission Content Protection over Internet Protocol (DTCP-IP) standard, and a proprietary standard.

5. The system of claim 1 further comprising a power saving circuit of at least one of the first security circuit and the second circuit to adjust voltage and frequency of at least one clock, memory, gate, and sub-circuit when not in operation to reduce power consumption of the system.

6. The system of claim 1 wherein the proprietary key is at least a 128 bit key, and wherein the work of authorship includes at least one of a video content, a motion-picture content, an audio content, a music content, a lyrical content, a graphical content, and a textual content.

7. The system of claim 1 wherein the display module to decompress the work of authorship after the decryption of the proprietary encrypted content, and to encrypt the decompressed content with a system master key provided from at least one of the display module and the host processor prior to sending the content to at least one of a video buffer and a display.

8. A method of an authorization module comprising:
applying an algorithm of an encryption standard to verify that a playback device has permission to playback the work of authorship;
re-encrypting the work of authorship protected by the encryption standard using a first hardware circuit that generates a proprietary key stored only in embedded hardware memory of the first hardware circuit to re-encrypt the work of authorship; and
storing a proprietary encrypted content generated through the re-encryption process in a system memory without storing any key information to decrypt the proprietary encrypted content in the system memory.

9. The method of claim 8 further comprising:
communicating an index pointer to a display module through a host processor; and
independently generating the proprietary key using an index pointer provided from the first hardware circuit associated with the authorization module to a second hardware circuit associated with the display module;
using the second hardware circuit to decrypt the proprietary encrypted content of the system memory using the independently generated proprietary key.

10. The method of claim 9 further comprising:
generating the proprietary key using the hash table, the number generator, a unique work of authorship identifier, and optionally a unique system identifier, wherein the hash table and the number generator of the first hardware circuit and the second hardware circuit are exactly the same.

11. The method of claim 10 wherein the index pointer references a location in embedded memory of the first hardware circuit and the second hardware circuit having identical data to enable the key generator circuit of the second hardware circuit to independently generate the proprietary key matching that of the first hardware circuit.

12. The method of claim 11 wherein the encryption standard is at least one of an Advanced Access Content System (AACS) standard, a BD+ (Blu-ray Disc) standard, a High-bandwidth Digital Content Protection (HDCP) standard, a Digital Transmission Content Protection over Internet Protocol (DTCP-IP) standard, and a proprietary standard.

13. The method of claim 12 wherein at least one of the first hardware circuit and the second hardware circuit adjusts a voltage and frequency of at least one clock, memory, gate, and sub-circuit when not in operation to reduce power consumption.

14. The system of claim 13 wherein the proprietary key is at least a 128 bit key, and wherein the work of authorship includes at least one of a video content, a motion-picture content, an audio content, a music content, a lyrical content, a graphical content, and a textual content.

15. The system of claim 14 wherein the display module to decompress the work of authorship after the decryption of the proprietary encrypted content, and to encrypt the decompressed content with a system master key provided from at least one of the display module and the host processor prior to sending the content to at least one of a video buffer and a display.

16. A playback device comprising:
an authentication component to verify that a protected content is authorized to be viewed on the playback device;
a media security circuitry to re-encrypt the protected content using a proprietary key after it is authorized to be viewed on the playback device using a secure embedded memory of the media security circuitry; and
a display component to receive the re-encrypted content from a system memory and to reference the media security circuitry to provide the proprietary key to decrypt the re-encrypted content.

17. The playback device of claim 16 wherein the encryption standard is at least one of an Advanced Access Content System (AACS) standard, a BD+ (Blu-ray Disc) standard, a High-bandwidth Digital Content Protection (HDCP) standard, a Digital Transmission Content Protection over Internet Protocol (DTCP-IP) standard, and a proprietary standard.

18. The playback device of claim 17 wherein the display module to decompress the work of authorship after the decryption of the proprietary encrypted content, and to encrypt the decompressed content with a system master key provided from at least one of the display module and the host processor prior to sending the content to at least one of a video buffer and a display.

19. The playback device of claim 16 wherein a memory map of the secure embedded memory and all hardware registers are never visible to software.

20. The playback device of claim 16 further comprising a key generator circuit of the secure embedded memory to generate the proprietary key using a hash table, a number generator, a unique work of authorship identifier, and optionally a unique system identifier.
